(19) United States
(12) Patent Application Publication
(10) Pub. No.: US 2011/0161737 A1
(43) Pub. Date: Jun. 30, 2011

(54) POST CODE MONITORING SYSTEM AND METHOD

(75) Inventor: XIANG-YUN KONG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/759,019

(22) Filed: Apr. 13, 2010

(30) Foreign Application Priority Data
Dec. 25, 2009 (CN) 200910312248.0

(51) Int. Cl. G06F 11/34; G06F 11/22

(52) U.S. Cl. 714/36; 714/E11.149; 714/E11.2

(57) ABSTRACT

A system is configured for monitoring power-on self-test (POST) codes generated by a motherboard under a power cycling test. The system includes a recording device configured to save the POST codes and a monitoring circuit board. The monitoring circuit board is configured to receive the POST codes from the motherboard and output the POST codes to the recording device. The monitoring circuit board is capable of displaying the POST codes one by one to indicate a current running state of the motherboard and outputting the POST codes in a format that the recording device is receivable. A method for monitoring power-on self-test (POST) codes generated by a motherboard under a power cycling test is also disclosed.

### BACKGROUND

1. Technical Field

The present disclosure relates to a system and method for monitoring power-on self-test (POST) codes generated by a motherboard.

2. Description of Related Art

After a motherboard is produced, a power cycling test is required. The power cycling test is performed for a predetermined number of test cycles. In one test cycle, the motherboard is powered on and then powered off. Almost immediately after the computer system is powered on, the basic input-output services (“BIOS”) firmware of the computer performs a series of brief tests on some of the fundamental hardware components of the computer such as the central processing unit (CPU), memory, display controller and keyboard controller. This series of tests is commonly known as the power-on self test (“POST”).

In a typical power cycling test system, a test circuit board is designed to execute the power cycling test on the motherboard. During the time the motherboard is undergoing the POST, the computer generates a plurality of POST codes. The test circuit board can display the POST codes one by one for indicating a current running state of the computer. However, the typical test system does not record all of the POST codes, and the same POST code may appear more than one time during POST. If errors occur and the motherboard is powered off during the POST, it's difficult to utilize the POST codes for locating the errors.

Therefore, a POST code monitoring system and method capable of recording all POST codes generated by a motherboard undergoing a power cycling test is desired.

### BRIEF DESCRIPTION OF THE DRAWINGS

FIG. 1 an block diagram of a POST code monitoring system in accordance with an embodiment.

FIG. 2 is a detailed block diagram of a recording device in FIG. 1 according to one embodiment.

FIG. 3 is a detailed block diagram of a monitoring circuit board in FIG. 1 according to one embodiment.

FIG. 4 is a flowchart of a POST code monitoring method in accordance to an embodiment

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

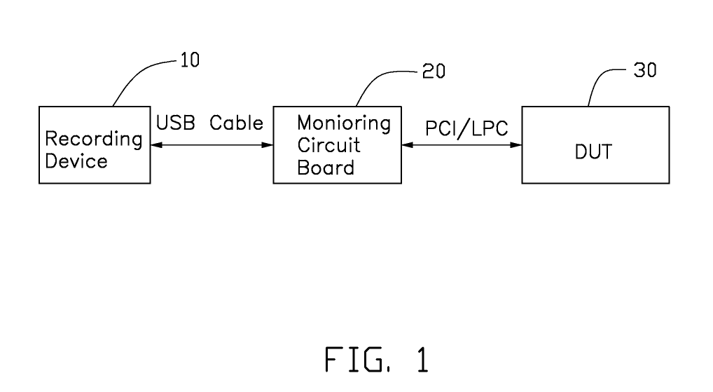

Referring to FIG. 1, an embodiment of a POST code monitoring system 100 includes a recording device 10, a monitoring circuit board 20, and a Device Under Test (DUT) 30. In one embodiment, the DUT 30 is a motherboard that undergoes a power cycling test and generates POST codes during the test. The monitoring circuit board 20 is connected to the DUT 30 via a Peripheral Component Interconnect (PCI) or a Low Pin Count (LPC) connection for receiving the POST codes. The recording device 10 is connected to the monitoring circuit board 20 via a Universal Serial Bus (USB) cable (or other cable or connection) to receive the POST codes from the monitoring circuit board 20.

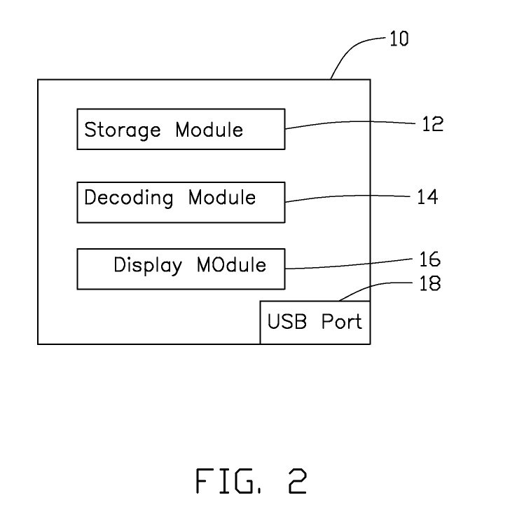

Referring to FIG. 2, the recording device 10 includes a storage module 12 for storing the POST codes of the DUT 30, a decoding module 14 for decoding the POST codes, a display module 16 capable of displaying a detailed message regarding each of the POST codes, and a USB port 18 connected to the monitoring circuit board 20. In one embodiment, the recording device 10 can be a computer.

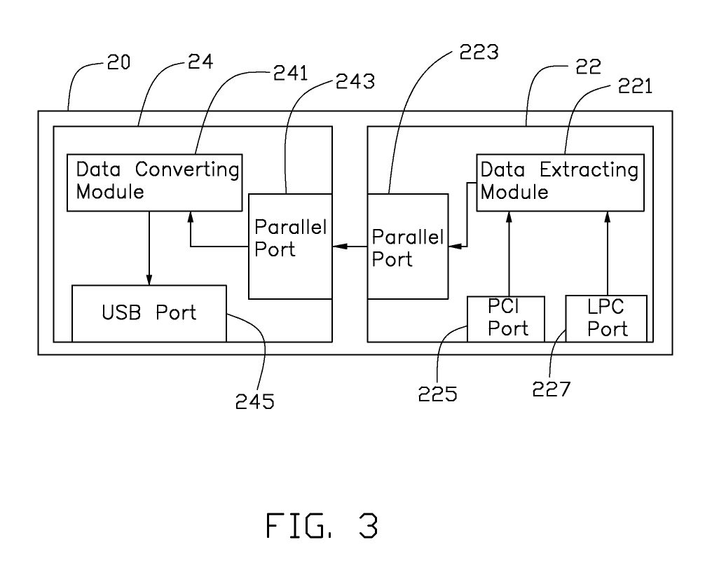

Referring to one embodiment shown in FIG. 3, the monitoring circuit board 20 includes a Complex Programmable Logic Device (CPLD) 22 and a USB First-In First-Out (FIFO) controller 24 connected to the CPLD 22.

The CPLD 22 includes a data extracting module 221, a parallel port 223, a PCI port 225, and a LPC port 227. One of the PCI port 225 and the LPC port 227 is connected to the DUT 30 for receiving data output from a PCI port or an LPC port of the DUT 30. The data output from the PCI port or the LPC port of the DUT 30 includes POST codes and other data. The data extracting module 221 is capable of extracting the POST codes from the data output from the DUT 30 and outputting the

POST codes from the parallel port 223 of the CPLD 22 to the USB FIFO controller 24.

The USB FIFO controller 24 includes a data converting module 241, a parallel port 243 connected to the parallel port 223 of the CPLD 22, and a USB port 245 connected to the USB port 18 of the recording device 10. The data converting module 241 is capable of converting the POST codes from a parallel format to a USB format. The USB port 245 sends the USB formatted POST codes to the recording device 10.

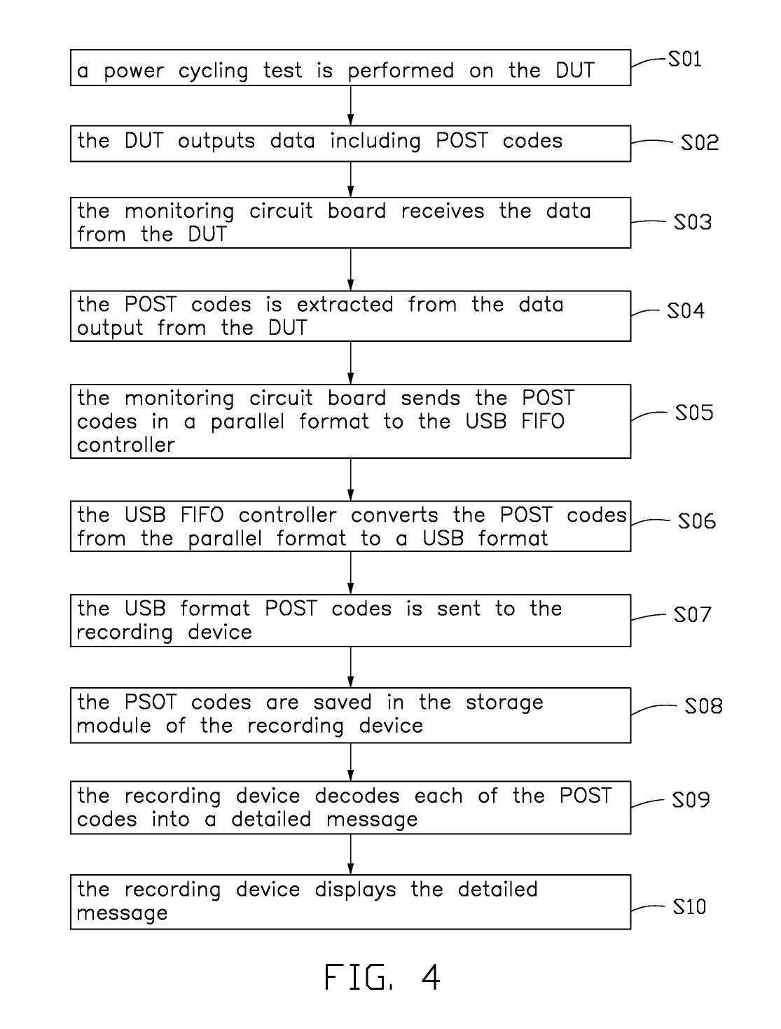

Referring to FIG. 4, an operational sequence, according to one embodiment of the system 100, includes the following blocks.

In block S01, a power cycling test is performed on the DUT 30 for periodically powering on and powering off the DUT 30.

In block S02, the PCI or LPC port of the DUT 30 is connected to the monitoring circuit board 20 and outputs data including POST codes to the monitoring circuit board 20.

In block S03, the monitoring circuit board 20 receives the data output from the PCI or LPC port of the DUT 30.

In block S04, the data extracting module 221 extracts the POST codes from the data output from the DUT 30.

In block S05, the CPLD 22 of the monitoring circuit board 20 sends the POST codes in a parallel format to the USB FIFO controller 24 from its parallel port 223.

In block S06, the data converting module 241 of the USB FIFO controller 24 converts the POST codes from the parallel format to a USB format.

In block S07, the USB formatted POST codes are sent from the USB port 245 of the monitoring circuit board 20 to the recording device 10.

In block S08, the PSOT codes are saved in the storage module 12 of the recording device 10.

In block S09, the decoding module 14 of the recording device 10 decodes each of the POST codes into a detailed message.

In block S10, the display module 16 of the recording device 10 displays the detailed messages.

In one embodiment, the recording device 10 records all of the POST codes generated by the motherboard and displays the detailed messages of the POST codes.

If an error occurs and the motherboard is powered off during POST, the operator can easily utilize the POST codes to determine where the error occurred, which facilitates repairing the motherboard.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A system for monitoring power-on self-test (POST) codes generated by a motherboard under a power cycling test, the system comprising:
a recording device configured to save the POST codes;
a monitoring circuit board configured to receive the POST codes from the motherboard and output the POST codes to the recording device, the monitoring circuit board capable of displaying the POST codes one by one to indicate a current running state of the motherboard and capable of outputting the POST codes in a format that the recording device is receivable.

2. The system of claim 1, wherein the monitoring circuit board comprises a Universal Serial Bus (USB) port capable of outputting the POST codes to the recording device.

3. The system of claim 2, wherein the monitoring circuit board includes a Complex Programmable Logic Device (CPLD) connected to the motherboard via a Peripheral Component Interconnect (PCI) or a Low Pin Count (LPC) connection.

4. The system of claim 3, wherein the CPLD includes a PCI port and a LPC port, one of the PCI port and the LPC port is connected to the motherboard for receiving datum outputted from the motherboard.

5. The system of claim 4, wherein the CPLD includes a data extracting module capable of extracting the POST codes from the datum outputted from the motherboard.

6. The system of claim 5, wherein CPLD further includes a parallel port for outputting the POST codes in a parallel format.

7. The system of claim 6, wherein the monitoring circuit board further comprising a USB FIFO controller connected to the parallel port of the CPLD.

8. The system of claim 7, wherein the monitoring circuit board includes a data converting module capable of converting the POST codes, received from the CPLD, from the parallel format to a USB format.

9. The system of claim 1, wherein the recording device is a computer.

10. The system of claim 9, wherein the computer comprises a storage module for storing the POST codes, a decoding module capable of decoding the POST codes, and a display module capable of displaying a message according to each of the POST codes.

11. A method comprising:
performing a power cycling test on a motherboard;
the motherboard outputting datum including power-on self-test (POST) codes;
extracting the POST codes from the datum;
converting the POST codes to Universal Serial Bus (USB) format; and
sending the USB format POST codes to a recording device.

12. The method of claim 11, further comprising connecting a monitoring circuit board to the motherboard via a Peripheral Component Interconnect (PCI) or Low Pin Count (LPC) connection, and the monitoring circuit board receives the POST codes from the motherboard.

13. The method of claim 12, further comprising connecting the monitoring circuit board to the recording device via a USB connection, and the recording device receives the USB format POST codes from the monitoring circuit board.

14. The method of claim 11, further comprising saving the POST codes in a storage module of the recording device.

15. The method of claim 14, further comprising decoding the POST codes in the recording device.

16. The method of claim 15, further comprising displaying a detailed message according to each of the POST codes.
